(19) United States
(12) Patent Application Publication
(10) Pub. No.: US 2012/0145281 A1
(43) Pub. Date: Jun. 14, 2012

(54) ROPE MOLDING JIG

(75) Inventor: Michael Robert Crowder, Pittsboro, IN (US)

(73) Assignee: WOODMASTER TOOLS, INC., Kansas City, MO (US)

(21) Appl. No.: 12/964,428

(22) Filed: Dec. 9, 2010

(51) Int. Cl. B27M 3/00; B27G 13/12

(52) U.S. Cl. 144/2.1

(57) ABSTRACT

A stock-shaping machine is operable to shape elongated stock and includes a powered machine and a jig. The powered machine includes a feed mechanism shiftably mounted relative to a frame so as to feed stock through the machine. The machine also includes a shaping device supported relative to the frame to shape the stock during feeding thereof. The elongated jig orients the stock so that an axis of the stock is at least generally parallel to a jig axis. The jig permits rotation of the stock relative to the jig about the stock axis and longitudinal sliding of the stock along the jig. The jig is mounted with the jig axis at an oblique angle relative to a machine feed axis so that shifting of the feed mechanism causes rotation and longitudinal sliding of the stock.

### BACKGROUND

1. Field

The present invention relates generally to equipment used to manufacture molding and similar products. More specifically, embodiments of the present invention concern a system and method of manufacturing rope molding.

2. Discussion of Prior Art

Various types of equipment have been used to manufacture wood moldings. One conventional molding machine includes a table, a rotating cutting head above the table, and a powered feed mechanism. The cutting head has a knife profile that corresponds to the shape of the molding. The feed mechanism urges stock through the machine so that the knife cuts a continuous molding shape that extends linearly along the length of the stock. Additionally, a conventional powered lathe can also be used to produce molding with a shape that varies along the length of the molding.

Conventional molding equipment and methods have certain deficiencies. For instance, prior art equipment and methods are unable to economically produce sections of continuous molding with helically shaped features. In particular, the prior art equipment cannot manufacture long molding sections with helical features that extend continuously along the length of the molding section.

### SUMMARY

The following brief summary is provided to indicate the nature of the subject matter disclosed herein. While certain aspects of the present invention are described below, the summary is not intended to limit the scope of the present invention.

Embodiments of the present invention provide a molding system that does not suffer from the problems and limitations of the prior art molding equipment set forth above.

A first aspect of the present invention concerns a stock-shaping assembly configured to shape elongated stock. The stock-shaping assembly broadly includes a powered machine and an elongated jig. The powered machine includes a frame, a stock feed mechanism shiftably mounted relative to the frame to feed the stock through the machine, and a shaping device supported relative to the frame to shape the stock during feeding thereof. The feed mechanism is shiftable in a feed direction and is thereby operable to drive the stock along a corresponding feed axis and thereby feed the stock through the powered machine. The elongated jig presents a stock-receiving surface that defines a jig axis and is operable to receive the stock so that an axis of the stock is at least generally parallel to the jig axis, with the jig permitting rotation of the stock relative to the jig about the stock axis and longitudinal sliding of the stock along the jig. The jig is mounted relative to the powered machine with the jig axis disposed at an oblique angle relative to the feed axis so that shifting of the feed mechanism is operable to cause rotation and longitudinal sliding of the stock with the shaping device operable to engage the stock along a helical path.

A second aspect of the present invention concerns a method of shaping an elongated stock. The broadly includes the steps of operating a feed mechanism that is designed to move the stock along a feed axis; orienting the stock so that the stock axis is held at an oblique angle relative to the feed axis, with the feed mechanism thereby causing the stock to simultaneously rotate about the stock axis and move axially along the stock axis; and shaping the stock as the stock is rotated and moved axially.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a left side perspective of a wood-shaping system constructed in accordance with a preferred embodiment of the present invention, with the system including a powered machine and a jig;

FIG. 2 is a right side perspective of the wood-shaping system shown in FIG. 1, with the powered machine including a lower stand and upright walls, a table shiftably supported by the stand and walls, a feed mechanism that draws stock through the machine, and a shaping mechanism that shapes the stock into rope molding;

FIG. 3 is a fragmentary left rear perspective of the wood-shaping system shown in FIGS. 1 and 2, showing the stock partly received in a groove of the jig, with a front portion of the stock being shaped to form the rope molding;

FIG. 4 is a fragmentary right rear perspective of the wood-shaping system shown in FIG. 3, particularly showing a table top, the jig secured to the table top, infeed and outfeed rollers of the feed mechanism positioned above the table top, and a cutting head assembly disposed above the table top and between the rollers, with a knife of the cutting head assembly in cutting engagement with the stock;

FIG. 5 is a fragmentary top view of the wood-shaping system shown in FIGS. 3 and 4, showing the jig disposed on the table so that a feed angle is defined by an axis of the groove and a feed axis of the machine, with the cutting head assembly including a cylindrical cutting head mounted on a driven arbor;

FIG. 6 is a fragmentary rear elevation of the wood-shaping system shown in FIGS. 3-5, showing the knife of the cutting head assembly in cutting engagement with the stock and disposed at a bottom dead center position;

FIG. 7 is a cross section of the wood-shaping system taken along line 7-7 in FIG. 5, showing the knife secured to the cylindrical cutting head with a gib;

FIG. 8 is a cross section of the wood-shaping system taken along line 8-8 in FIG. 5, showing the cross-sectional shape of the jig groove, with the stock disposed in the groove;

FIG. 9 is a fragmentary front perspective of the cutting head assembly shown in FIGS. 1-8, showing the gib held in engagement with the blade by a pair of gib screws;

FIG. 10 is a fragmentary rear perspective of the cutting head assembly shown in FIGS. 1-9; and

FIG. 11 is a fragmentary rear perspective of the cutting head assembly of FIG. 10, but showing the blade, gib, and gib screws exploded from the cutting head.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

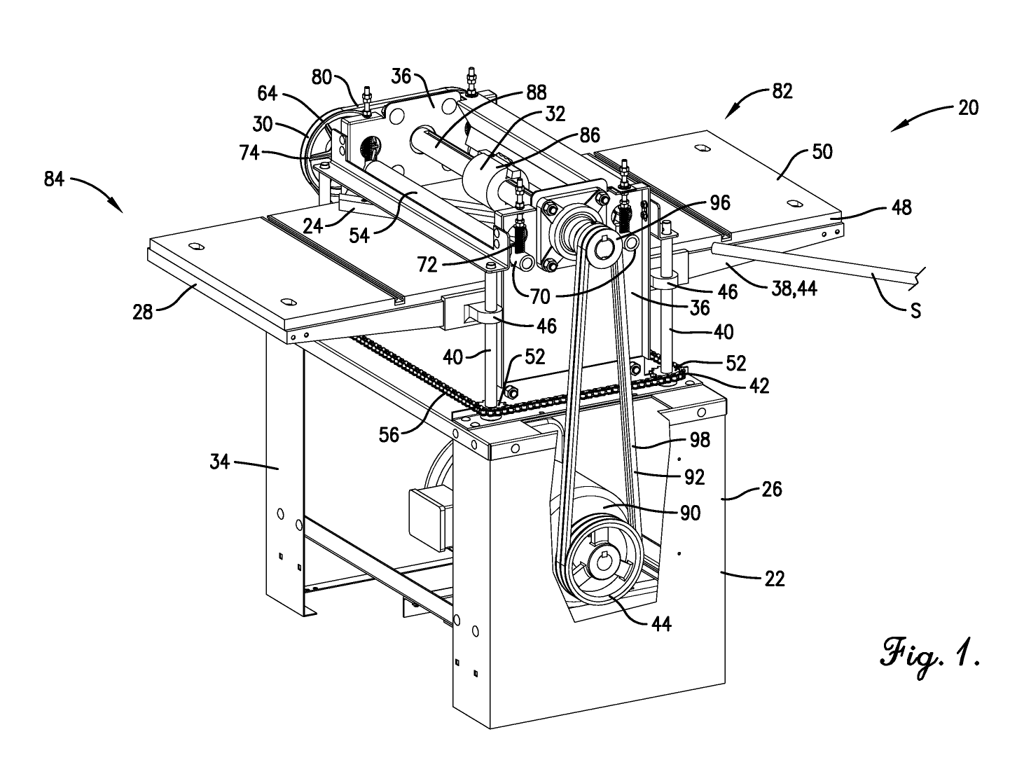

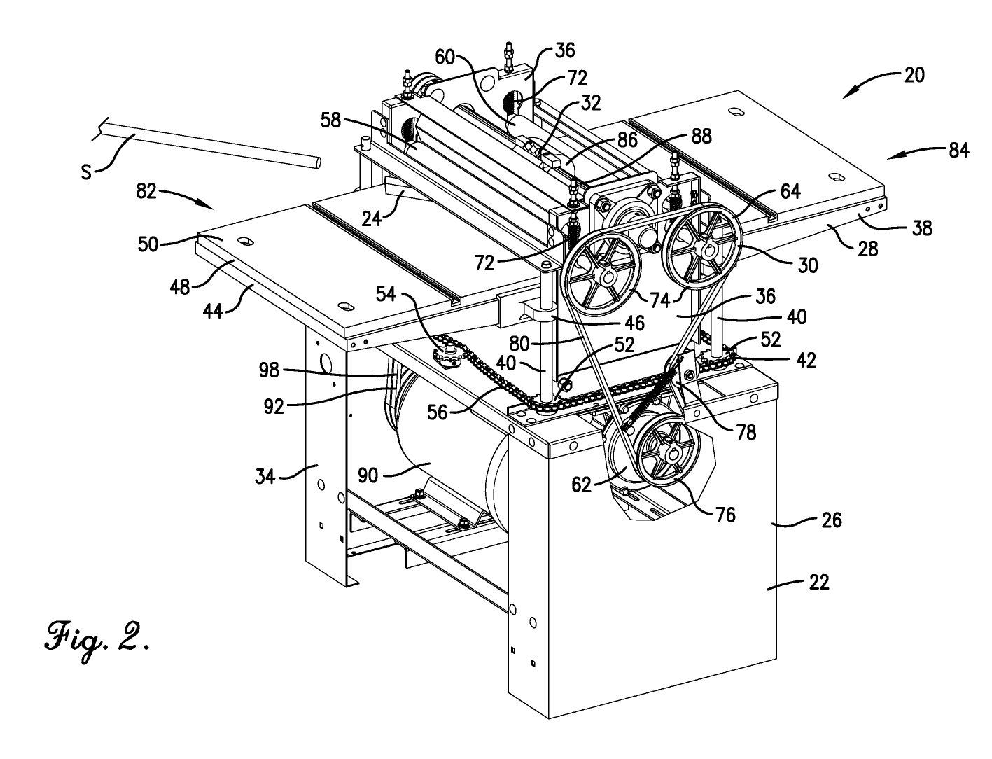

Turning initially to FIGS. 1 and 2, a wood-shaping system 20 is constructed in accordance with a preferred embodiment of the present invention and is preferably used to produce a continuous molding M from dowel stock S, as will be discussed. The system 20 broadly includes a powered machine 22 and a jig 24.

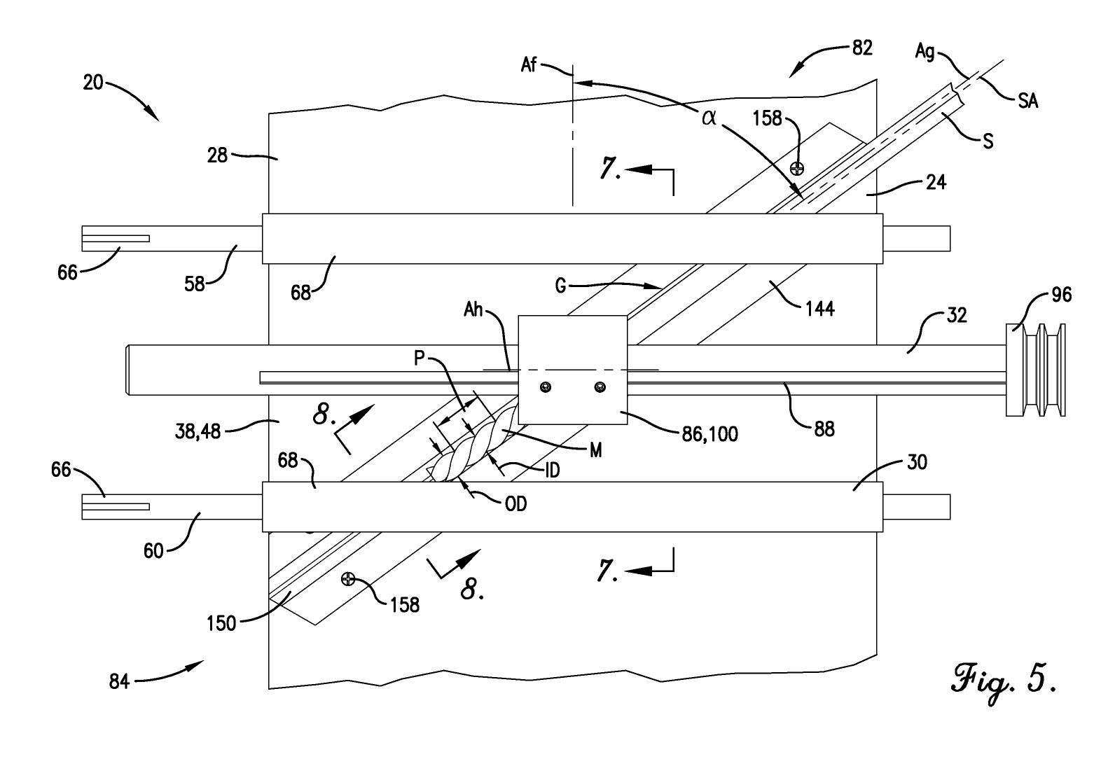

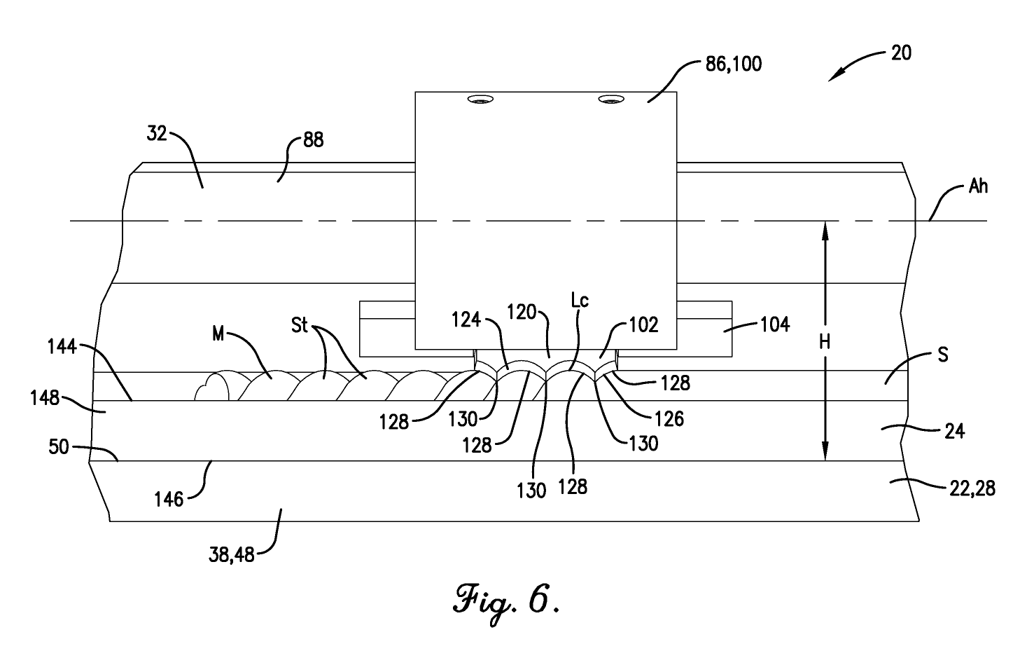

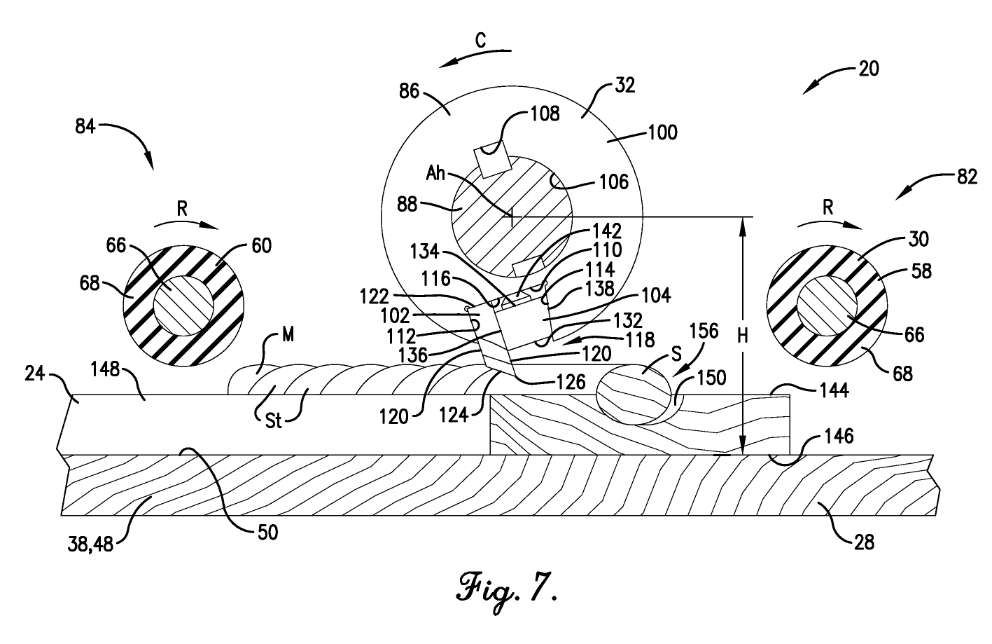

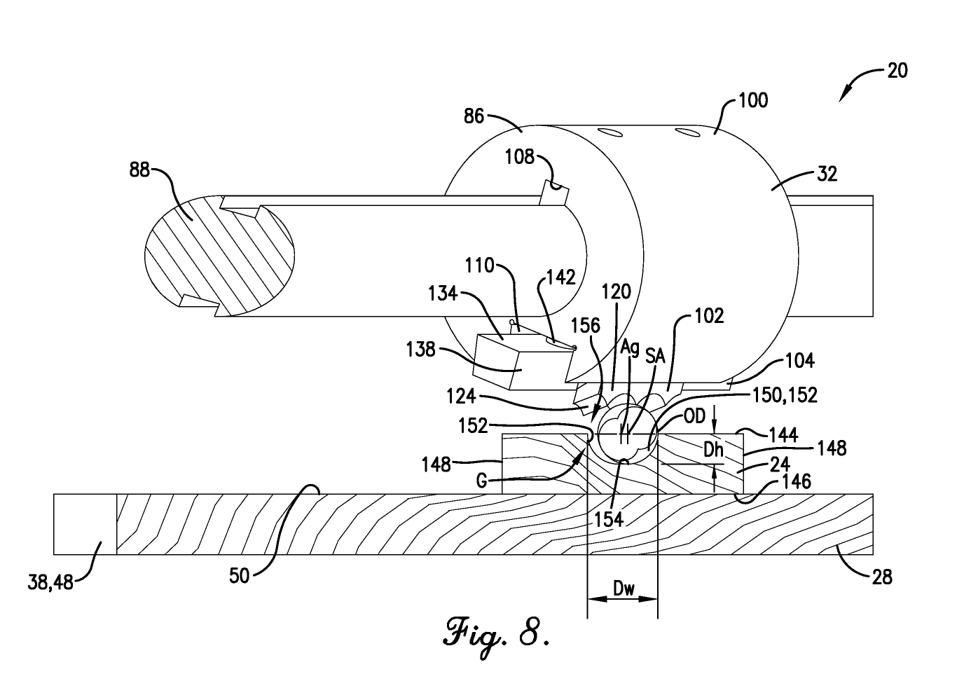

Turning to FIGS. 5-8, the illustrated system 20 is preferably configured to form molding M with helical features from dowel stock S. The illustrated molding M preferably has the shape of a continuous rope and includes a pair of continuous twisted strand surfaces St (see FIGS. 6 and 7). Specifically, the strand surfaces St are each defined by a generally convex cross-sectional profile that extends along a helical direction about a stock axis SA (see FIGS. 5 and 8) so as to imitate the general shape of a helically-wound rope strand that is used to form a twisted rope (also referred to as laid rope). The strand surfaces St are shaped to define a pitch distance dimension P, an outer diameter dimension OD, and an inner diameter dimension ID of the molding M (see FIG. 5).

The principles of the present invention are equally applicable where the molding M produced by the system 20 has alternative surface features. For instance, the molding could be formed to present an alternative number of strand surfaces St (i.e., one strand surface or more than two strand surfaces). Also, the strand surfaces St could present alternative dimensions P, OD, ID. Furthermore, the strand surfaces St could have an alternative cross-sectional profile to provide a desired strand shape. While the illustrated strand surfaces St extend continuously, the strand surfaces St could each include multiple surface segments separated from one another and arranged end-to-end. For some aspects of the present invention, the system 20 could be configured to form molding M with a generally circular profile that is substantially devoid of helical grooves.

The illustrated stock S is preferably made of wood. Furthermore, the system 20 is preferably configured to shape wooden stock. However, the principles of the present invention are equally applicable where the system 20 is employed to shape other stock materials, such as a synthetic resin material, and thereby form decorative moldings of various materials.

The illustrated powered machine 22 is operable to form various molding designs. The powered machine 22 preferably includes a frame 26, table assembly 28, feed system 30, and shaping system 32. In the usual manner, the frame 26 supports the rest of the machine 22 at a suitable height for operation. The illustrated frame 26 includes a lower stand 34 and a pair of upright walls 36. The lower stand 34 includes sides and a generally rectangular top. The upright walls 36 are mounted adjacent to opposite ends of the top. As will be discussed, the walls 36 serve to support components of the feed system 30 and shaping system 32.

The illustrated table assembly 28 provides a platform to support and position stock S as the stock S is moved through the machine 22. The table assembly 28 preferably includes a table 38, threaded rods 40, and a table drive assembly 42. The table 38 includes a generally rectangular base 44 and threaded brackets 46 attached to sides of the base 44. The table 38 further includes a top 48 that is mounted to the base 44. The top 48 includes a deck preferably made of wood (although the deck could include other materials) and a pair of channels secured to the deck. The top 48 presents a top surface 50 that receives the jig 24, as will be discussed.

The rods 40 are each supported adjacent to a corresponding wall 36 for rotation about a vertical axis. The rods 40 extend through and are threadably received by respective brackets 46. Thus, rotation of each rod 40 causes the respective bracket 46 to shift vertically.

The drive assembly 42 includes driven sprockets 52 fixed to the lower ends of respective rods, a drive sprocket 54, and a chain 56 that interconnects the sprockets 52,54. Thus, driving rotation of the drive sprocket 54 causes synchronized rotation of the driven sprockets 52 and rods 40. The table height is increased by rotating the drive sprocket 54 counterclockwise (when viewing the sprocket 54 from above the table 38), which results in corresponding clockwise rotation of the chain 56 and rods 40. Clockwise rotation of the rods 40 causes upward movement of the table 38. Similarly, table height is decreased by rotating the drive sprocket 54 in the clockwise direction, which causes counterclockwise rotation of the chain 56 and rods 40. In this manner, the table height can be adjusted by uniformly raising or lowering the table 38 relative to the frame 26. As will be discussed, the shaping system includes a rotating cutting head that is rotatably mounted to the frame 26. The table height is adjustable to change a head height dimension H between the top surface 50 and an axis Ah of the cutting head (see FIGS. 6 and 7).

Turning to FIGS. 2-7, the feed system 30 is operable to feed stock S along a feed axis Af of the machine 22. The illustrated feed system 30 preferably includes infeed and outfeed rollers 58,60, a motor 62, and a transmission 64 that drivingly interconnects the rollers 58,60 and motor 62 (see FIG. 5).

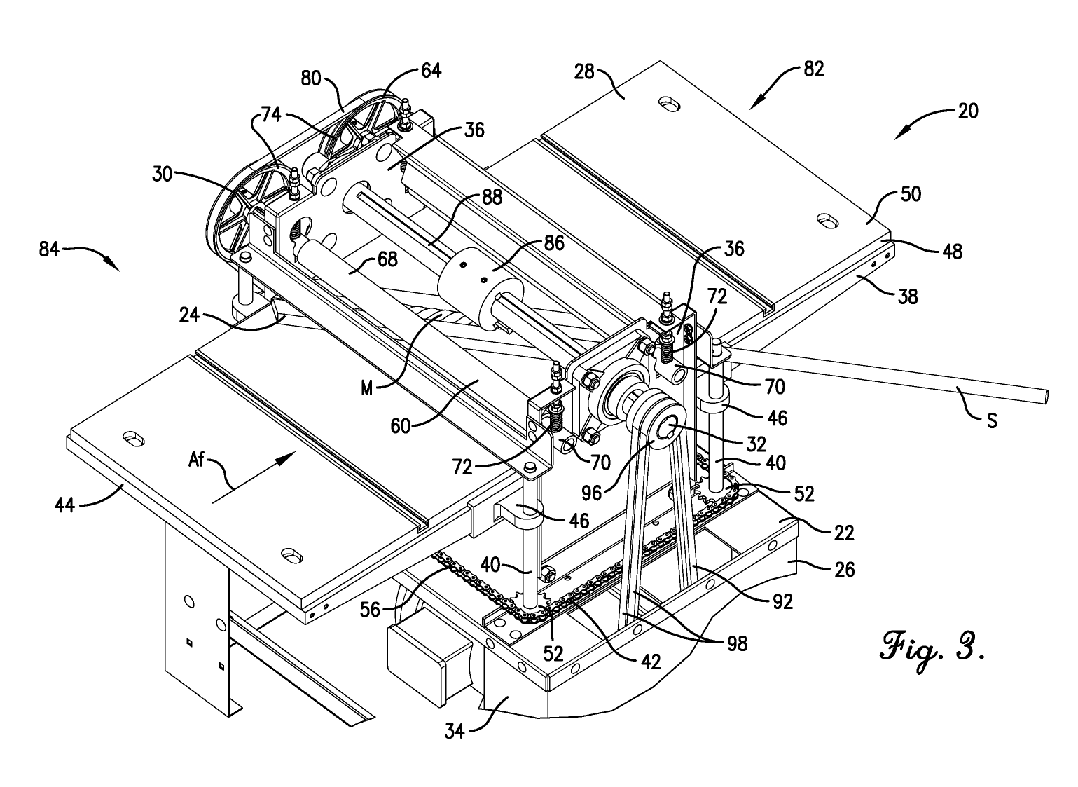

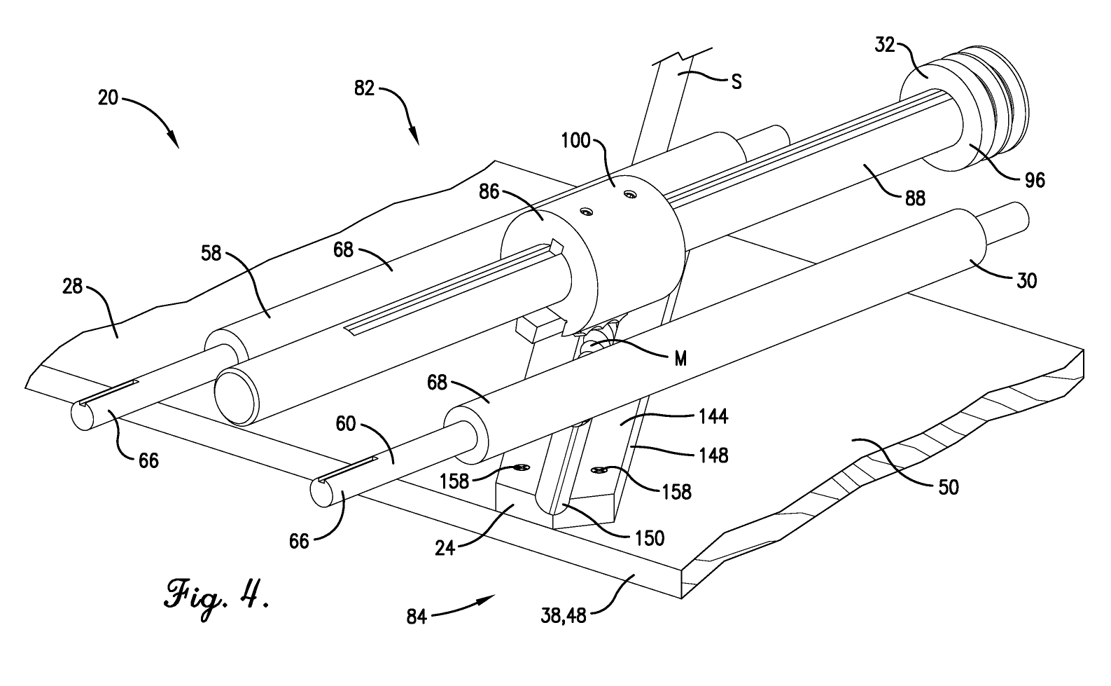

The rollers 58,60 each preferably include a driven shaft 66 and a sleeve 68 mounted to rotate with the shaft 66 (see FIGS. 4 and 5). Each of the rollers 58,60 is rotatably supported adjacent each end thereof by sleeves 70 that are slidably mounted to the upright walls 36. Spring assemblies 72 are positioned above the sleeves 70 and interconnect the walls 36 and sleeves 70 so that the rollers 58,60 are resiliently urged in a generally downward direction (see FIG. 3). In this manner, the rollers 58,60 are urged into frictional engagement with the stock S.

Although the illustrated feed system 30 preferably includes rollers 58,60, the principles of the present invention are applicable where the feed system 30 has only one of the rollers (e.g., where the feed system 30 is devoid of out-feed roller 60). Furthermore, the feed system 30 could have a drive mechanism other than rollers to engage and drive the stock S through the machine 22 (e.g., the drive mechanism could include a flexible driven belt with a lower belt run that extends along the feed axis Af to drivingly engage the stock S).

The illustrated transmission 64 preferably includes driven pulleys 74 mounted to the rollers 58,60, a drive pulley 76 mounted to the shaft of motor 62, a spring-loaded idler pulley 78, and a belt 80 drivingly entrained on the pulleys 74,76,78 (see FIG. 2). However, the transmission 64 could be alternatively configured to power the rollers 58,60 without departing from the scope of the present invention. The illustrated transmission 64 drivingly connects the motor 62 and rollers 58,60 so that motor shaft rotation in a forward direction causes corresponding rotation of both rollers 58,60 in a forward feed direction R (see FIG. 7). However, in some instances (e.g., to remove stock from the machine), the motor 62 can be reversed so that the rollers 58,60 are both driven in a reverse feed direction.

The feed system 30 defines infeed and outfeed sections 82,84 of the table 38 in connection with forward travel of stock through the machine 22. That is, stock S is advanced in a forward direction from the infeed section 82 to the outfeed section 84. Initially, the stock S is preferably manually fed into engagement with the infeed roller 58, although the stock could also be machine-fed into roller engagement. With the infeed roller 58 engaging the stock S, the infeed roller 58 grabs and drives the stock S along the feed axis Af toward the outfeed roller 60 so that the outfeed roller 60 can also drivingly engage the stock S. The rollers 58,60 preferably rotate at the same speed so as to cooperatively drive the stock S through the machine 22 from the infeed section 82 to the outfeed section 84.

Turning to FIGS. 1-5, the shaping system 32 is used to form molding M from the stock S. The shaping system 32 preferably includes a cutting head assembly 86, driven arbor 88, motor 90, and transmission 92. The arbor 88 is rotatably supported by bearings that are mounted to respective upright walls 36. The transmission 92 includes pulleys 94,96 mounted respectively on the shaft of motor 90 and the arbor 88, with endless belts 98 entrained on the pulleys 94,96. The transmission 92 interconnects the motor 90 and arbor 88 so that forward motor shaft rotation causes corresponding forward cutting head rotational direction C (see FIG. 7). Thus, in the illustrated embodiment, cutting head rotation in the direction C generally opposes the forward feed direction R.

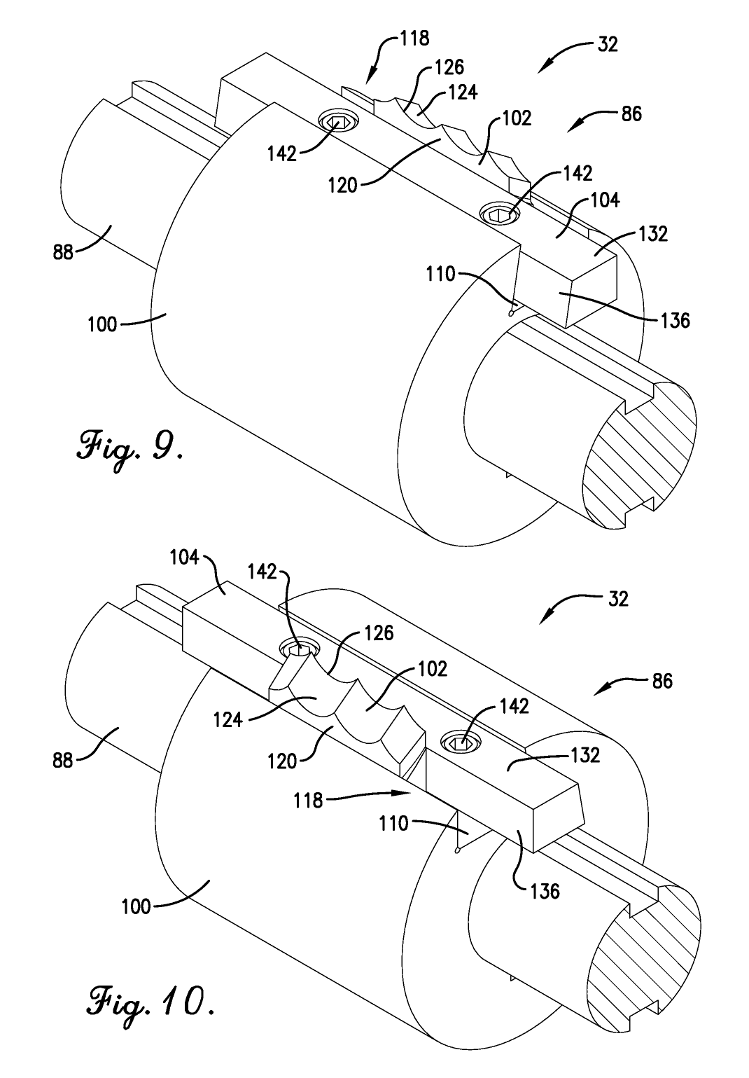

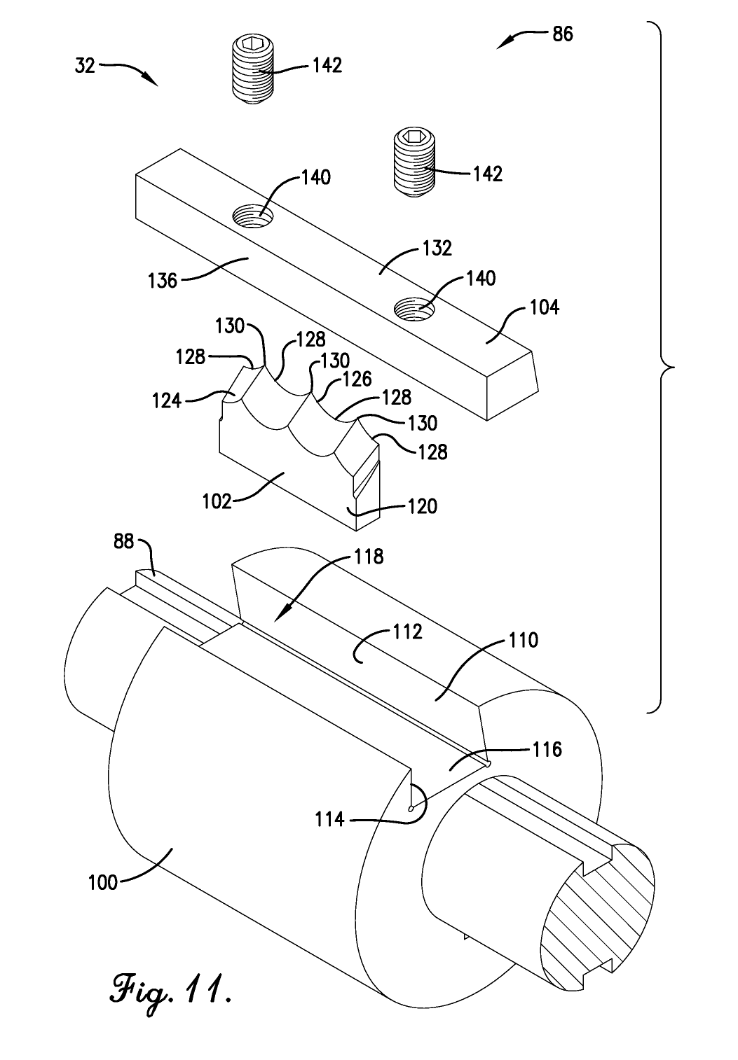

Turning to FIGS. 6-11, the cutting head assembly 86 preferably includes a generally cylindrical head 100, a knife 102, and a gib 104 to secure the knife 102 to the head 100. The head 100 presents a centrally disposed bore 106 that extends longitudinally between opposite ends of the head 100, with the bore 106 including a keyway 108. The head 100 also presents an outer groove 110 that extends longitudinally between the ends of the head 100. The groove 110 includes side sections 112,114 and base section 116 and defines a longitudinally extending open face 118 (see FIGS. 7 and 11). Preferably, the side sections 112,114 taper toward each other in a direction from the base section toward the open face 118 for securing the knife 102. The head 100 is secured to the arbor 88 by aligning the keyway 108 with a keyway presented by the arbor 88 and by removably inserting a key into engagement with the aligned keyways.

The illustrated knife 102 is unitary and preferably presents knife side surfaces 120, a base surface 122, and a shaped surface 124, with a knife edge 126 being defined by the shaped surface 124. The knife edge 126 preferably includes scallops 128 that terminate at vertices 130 (see FIGS. 7 and 11). However, it is within the ambit of the present invention where the knife 102 presents an alternative knife edge. Furthermore, the knife 102 could have an alternative configuration for other purposes (e.g., for alternative securement of the knife 102 to the head 100).

Turning to FIGS. 7-11, the gib 104 preferably comprises an elongated unitary bar that presents top and bottom surfaces 132,134 and side surfaces 136,138. The illustrated side surfaces 136,138 taper toward each other from the bottom surface 134 to the top surface 132 so that the gib 104 has a cross-sectional wedge-shaped profile. The gib 104 further presents threaded holes 140 that extend from the top surface 132 to the bottom surface 134 (see FIG. 11).

The gib 104 is inserted in the groove 110 so that the bottom surface 134 is positioned adjacent the base section 116 of the groove 110 and the top surface 132 is positioned adjacent the open face 118 of the groove 110. Additionally, the gib 104 and knife 102 are positioned side-by-side, with one side surface 120 of the knife 102 being opposed to side surface 136. Fasteners 142 in the form of set screws are adjustably threaded into respective holes 140 to secure the gib 104 and knife 102 onto the head 100. As the fasteners 142 are threaded in a direction from the top surface 132 to the bottom surface 134, the fasteners 142 shift the gib 104 toward the open face 118 of the groove 110. At the same time, the side surface 138 of the gib 104 and side section 114 of the groove 110 direct the gib 104 into an engagement condition, where the side surfaces 136,138 of the gib 104 engage the side section 114 and knife 102 at the same time. In this manner, the knife 102 is preferably frictionally secured to the head 100. However, the principles of the present invention are equally applicable where knife 102 is secured to the head 100 using an alternative construction. Furthermore, the knife 102 could be permanently fixed to the head 100.

As mentioned, the table height is adjustable to change the height dimension H between the top surface 50 and the axis Ah of the head 100. The cutting depth of the knife 102 is decreased by increasing the height dimension H. Similarly, the cutting depth is increased by decreasing the height dimension H.

The illustrated knife arrangement has been found to be particularly effective for shaping of stock S as disclosed herein. But another rotatable cutting device, such as a sanding drum or a grinding wheel, could be employed without departing from the scope of the present invention. For some aspects of the present invention, a non-rotating cutting tool could also be used as part of a shaping machine, e.g., where a knife is held stationary relative to the table during shaping.

Turning to FIGS. 4-8, the jig 24 generally extends between the infeed and outfeed sections 82,84 of the table 38 and is configured to position the stock S for operation of the machine 22. The illustrated jig 24 has an elongated unitary body, although the jig body could include multiple components. The jig body presents a top surface 144, bottom surface 146, and side surfaces 148 that extend longitudinally. The top surface 144 preferably includes a groove 150 that extends continuously between ends of the jig 24 and defines a longitudinal groove axis Ag, which serves as an axis of the jig 24 (see FIGS. 5 and 8). Preferably, the groove 150 includes opposite curved sides 152, a base 154, and an open face 156 (see FIG. 8). Each of the illustrated sides 152 has a cross-sectional profile in the shape of an arc that extends through an angle of about ninety degrees, with a substantially constant side radius. Preferably, the radius of the stock S is about equal to or less than the side radius. The sides 152 are preferably separated by the base 154. Thus, when the stock S is disposed in the groove 150 and contacts one of the sides 152, a gap G is preferably formed between the stock S and the other side 152 (see FIGS. 5 and 8). This gap G is provided to permit sliding movement of the stock with relatively low friction between the stock S and groove 150.

The groove 150 presents a groove height dimension Dh and a groove width dimension Dw that are measured transversely to the groove axis Ag (see FIG. 8). Preferably, the open face 156 defines a maximum width of the groove. However, it is also within the scope of the present invention where the groove has a maximum groove width at a location between the base 154 and open face 156. For instance, the open face 156 could have a width dimension smaller than the stock diameter so that the jig 24 restricts stock insertion into (and removal from) the groove 150 by passing the stock S through the open face 156.

The illustrated shape of the groove 150 permits the stock S to slide smoothly along the groove axis Ag while also rotating about the stock axis SA. However, for some aspects of the present invention, the groove 150 could present an alternative shape. For instance, the sides 152 could be substantially planar (e.g., where the sides 152 are disposed at aright angle to the base 154 so that the groove 150 has a generally rectangular profile). Also, while the depicted groove 150 extends continuously between ends of the jig 24, the groove 150 could have sections that are differently shaped. For instance, the jig 24 could present infeed and outfeed groove sections that are different from each other and associated with respective sides of the table 38. The distinct groove sections could have one or more features (such as groove height or groove profile shape) that are different from each other. For example, where the outer diameter dimension OD of the molding M is designed to be substantially less than the stock diameter, the infeed groove section could have a groove height that is larger than the groove height of the outfeed groove section so that the stock S is evenly supported across both groove sections.

Furthermore, it is within the ambit of the present invention where the jig 24 is constructed so that the groove 150 can be adjustably sized. For instance, the jig 24 could have sides that are shiftable relative to one another to increase or decrease the groove width dimension Dw (e.g., to accommodate different sizes of stock S).

The illustrated jig 24 is preferably disposed on the table 38 so that the molding M is formed to present the twisted strand surfaces St. Specifically, the jig 24 is arranged at a feed angle α relative to the feed axis Af so that the stock S travels a distance of one pitch distance dimension P as the stock S rotates through a complete revolution about the stock axis SA (see FIG. 5). The pitch distance dimension P is preferably selectively adjustable by changing the feed angle α.

The illustrated jig 24 is also preferably positioned so that a vertical plane through the stock axis SA intersects the knife edge 126 approximately at centering location Lc spaced evenly between two adjacent vertices 130 when the knife 102 is at a bottom dead center (BDC) position (see FIGS. 6 and 7). Although the head axis Ah and stock axis SA are not parallel with each other, this knife configuration permits the two adjacent vertices 130 to cut corresponding flutes between respective surfaces St so that the flutes present substantially the same inner diameter dimension Di.

The system 20 is configured so that the jig 24 is shiftable through a jig adjustment angle that ranges between a maximum positive feed angle α of about sixty (60) degrees and a maximum negative feed angle α of about negative sixty (−60) degrees. The construction of upright walls 36 limits the maximum feed angles α. However, the machine 22 could be alternatively configured so that maximum positive feed angle α could be greater than about sixty (60) degrees and the maximum negative feed angle α could be less than about negative sixty (−60) degrees.

In the illustrated embodiment, the jig 24 is arranged at a negative feed angle α of about negative fifty-three (−53) degrees so that the strand surfaces St have the appearance of S-twist rope strands. However, the jig 24 could be arranged with a positive feed angle α so that the strand surfaces St have the appearance of Z-twist rope strands.

The jig 24 is preferably positioned so that the feed angle α comprises an oblique angle. For example, the groove axis Ag is preferably arranged in a non-parallel orientation relative to the feed axis Af. In this manner, driving engagement by the rollers 58,60 causes the stock S to slide and rotate within the groove 150. Initially, when one (or both) of the rollers 58,60 rotate in the forward feed direction R while engaging the stock S, the stock S is urged into sliding contact with a forward one of the sides 152. At the same time, the stock S becomes spaced from a rear one of the sides 152 so that the gap G is presented therebetween. Continued driving engagement with the stock S causes the stock to slide along the groove axis Ag and rotate within the groove 150 about the stock axis SA.

The jig 24 is preferably removably attached to the wooden top 48 with multiple fasteners 158. Thus, the jig 24 can be selectively attached at different feed angles α using the fasteners 158. However, the principles of the present invention are applicable where the jig 24 is alternatively attached to the table 38. For instance, the jig 24 could be pivotally attached to the table 38 at a pivot location adjacent the head 100 so that the jig 24 can be swung continuously through the jig adjustment angle while maintaining alignment between the knife 102 and the groove 150.

As mentioned above, the jig 24 is arranged so that the feed axis Af and groove axis Ag form an oblique angle, with the stock S being driven by the rollers to slide axially and rotate about the stock axis at the same time. Thus, as the stock S is fed through the machine 22, the knife 102 of the cutting head assembly 86 engages the stock S along a continuous helical path with pitch distance dimension P to form the continuous strand surfaces St.

In operation, the system 20 is initially setup by positioning and attaching the jig 24 to the machine 22. The jig 24 is positioned with the feed angle α at the predetermined angle. Furthermore, the jig 24 is preferably positioned so that the vertical plane through the stock axis SA intersects the knife edge 126 approximately at centering location Lc when the knife 102 is at the BDC position. With the jig 24 secured, the feed system 30 can be engaged so that the rollers 58,60 are driven in the same forward feed direction R (i.e., so that stock S can be fed from the infeed section 82 to the outfeed section 84 of the table 38).

The stock S is oriented for shaping by manually positioning a forward end of the stock S in the groove 150 along the infeed section 82. Furthermore, the stock S is fed manually along the groove axis Ag and toward the cutting head. Once a forward end of the stock S is engaged by infeed roller 58, the feed system 30 and jig 24 cooperatively hold the stock so that the stock axis SA is at an oblique angle relative to the feed axis Af. The rollers 58,60 rotate about the feed direction R to draw the stock S through the machine 22 by sliding the stock S along the groove axis Ag and simultaneously rotating the stock S about the stock axis SA. As the stock S is fed through the machine 22, the knife 102 of the cutting head assembly 86 rotates about the forward rotation direction C and engages the stock S to shape the strand surfaces St, which extend along a helical path. Furthermore, the feed system 30 and jig 24 continue to hold the stock axis SA at the oblique angle relative to the feed axis Af.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A stock-shaping assembly configured to shape elongated stock, said stock-shaping assembly comprising:
a powered machine including a frame, a stock feed mechanism shiftably mounted relative to the frame to feed the stock through the machine, and a shaping device supported relative to the frame to shape the stock during feeding thereof,
said feed mechanism shiftable in a feed direction and thereby operable to drive the stock along a corresponding feed axis and thereby feed the stock through the powered machine; and
an elongated jig presenting a stock-receiving surface that defines a jig axis and is operable to receive the stock so that an axis of the stock is at least generally parallel to the jig axis, with the jig permitting rotation of the stock relative to the jig about the stock axis and longitudinal sliding of the stock along the jig,
said jig being mounted relative to the powered machine with the jig axis disposed at an oblique angle relative to the feed axis so that shifting of the feed mechanism is operable to cause rotation and longitudinal sliding of the stock, with the shaping device operable to engage the stock along a helical path.

2. The stock-shaping assembly as claimed in claim 1,
said stock-receiving surface being recessed and defining a longitudinally extending groove that presents an arcuate cross-sectional profile and is configured to slidably receive the stock.

3. The stock-shaping assembly as claimed in claim 2,
said stock-receiving surface including longitudinally-extending side surface sections that generally oppose each other so as to restrict lateral movement of the stock relative to the jig.

4. The stock-shaping assembly as claimed in claim 3,
said jig being substantially unitary so that the side surface sections are fixed relative to one another.

5. The stock-shaping assembly as claimed in claim 2,
said groove including an open face,
said groove presenting a groove width dimension measured transversely to the jig axis, with the open face defining the maximum groove width.

6. The stock-shaping assembly as claimed in claim 1,
said jig being adjustably mounted to the power machine so that pitch of the helical path can be adjusted.

7. The stock-shaping assembly as claimed in claim 1; and
a table disposed below the feed mechanism and cutting device, with the jig being mounted on the table,
said table including an infeed section associated with an infeed side of the cutting device and an outfeed section associated with an outfeed side of the cutting device.

8. The stock-shaping assembly as claimed in claim 7; and
a stand that supports the feed mechanism and cutting device,
said table being shiftably supported on the stand and shiftable along a vertical direction to adjustably position the jig relative to the cutting device.

9. The stock-shaping assembly as claimed in claim 1,
said feed mechanism including a powered roller to drive the stock, with rotation of the powered roller causing the rotational and longitudinal movement of the stock within the jig.

10. The stock-shaping assembly as claimed in claim 9,
said feed mechanism including another powered roller,
both of said rollers being simultaneously rotatable to cooperatively drive the stock.

11. The stock-shaping assembly as claimed in claim 10; and
a table disposed below the feed mechanism and cutting device, with the jig being mounted on the table,
said table including an infeed section associated with an infeed side of the cutting device and an outfeed section associated with an outfeed side of the cutting device,
one of said rollers being disposed along the infeed section to direct stock toward the cutting device and the other of said rollers being disposed along the outfeed section to direct stock away from the cutting device.

12. The stock-shaping assembly as claimed in claim 1,
said cutting mechanism including a rotating cutting head assembly.

13. The stock-shaping assembly as claimed in claim 12,
said cutting head assembly including a head that spins about an axis transverse to the jig axis.

14. The stock-shaping assembly as claimed in claim 12,
said cutting head assembly including a cutting head and a knife mounted to the cutting head,
said knife presenting an elongated cutting edge that shapes the stock.

15. A method of shaping an elongated stock, said method comprising the steps of:
(a) operating a feed mechanism that is designed to move the stock along a feed axis;
(b) orienting the stock so that the stock axis is held at an oblique angle relative to the feed axis, with the feed mechanism thereby causing the stock to simultaneously rotate about the stock axis and move axially along the stock axis; and
(c) shaping the stock as the stock is rotated and moved axially.

16. The method as claimed in claim 15,
step (a) including the step of rotating a powered roller of the feed mechanism,
said rotating roller extending transversely relative to the feed axis, with rotation of the powered roller about the roller axis causing the stock to rotate and move axially.

17. The method as claimed in claim 15,
step (b) including the step of retaining the stock in sliding engagement with a jig so that the jig axis is generally parallel to the stock axis.

18. The method as claimed in claim 17,
said jig presenting a longitudinally extending groove configured to slidably receive the stock,
step (b) including the step of locating the jig adjacent the feed mechanism so that the feed mechanism retains the stock in sliding engagement with the groove as the stock is rotated and moved axially.

19. The method as claimed in claim 18,
said feed mechanism being positioned above a table,
step (b) including the step of mounting the jig on the table so that the jig is located below the feed mechanism.

20. The method as claimed in claim 15,
step (c) including the step of rotating a cutting head, with the rotating cutting head engaging the stock to remove stock material and thereby shape the stock.
